(19) United States
(12) Patent Application Publication
(10) Pub. No.: US 2026/0227255 A1
(43) Pub. Date: Aug. 6, 2026

(54) MEASUREMENT ROLLER AND METHOD FOR PRODUCING SAME

(71) Applicant: ACHENBACH BUSCHHÜTTEN GMBH & CO. KG, Kreuztal (DE)

(72) Inventors: André BARTEN, Siegen (DE); Markus CRAMER, Attendorn (DE); Bernd DORNSEIFER, Freudenberg (DE)

(21) Appl. No.: 19/149,914

(22) PCT Filed: Nov. 15, 2023
(86) PCT No.: PCT/EP2023/081888

§ 371 Date: Jul. 22, 2025

(30) Foreign Application Priority Data
Jan. 24, 2023 (DE) 10 2023 101 652.0

(51) Int. Cl. G01L 5/108; G01K 13/08; G01L 5/00

(52) U.S. Cl. CPC G01L 5/108; G01L 5/0004; G01K 13/08

(57) ABSTRACT

The invention relates to a measuring roll and to a method for producing a measuring roll for measuring at least one property, in particular a tape tensile force, a tape temperature or the like, of a good guided over the measuring roll, the measuring roll having a measuring-roll body (11) which forms a circumferential surface (13) of the measuring roll, the measuring roll having at least one sensor arrangement (14), the sensor arrangement being formed by at least one cavity (15) which is formed within the circumferential surface and in which at least one sensor is received, the cavity being designed so as to be closed flush with the circumferential surface by means of a lid (22) of the sensor arrangement, the lid being in a mechanically operative connection with the sensor. The lid is substance-bonded with the measuring-roll body, the lid on the circumferential surface having a wall.

The invention relates to a measuring roll and a method for producing a measuring roll for measuring at least one property, in particular a tape tensile force, a tape temperature or the like, of a good guided over the measuring roll, the measuring roll having a measuring-roll body which forms a circumferential surface of the measuring roll, the measuring roll having at least one sensor arrangement, the sensor arrangement being formed by at least one cavity which is formed within the circumferential surface and in which at least one sensor is received, the cavity being designed so as to be closed flush with the circumferential surface by means of a lid of the sensor arrangement, the lid being in a mechanically operative connection with the sensor.

Measuring rolls and methods of the type mentioned above are used in particular for measuring a tape tensile force in a tape material which is used to produce films, tapes or webs, such as aluminum foils in particular. A measuring roll is known from DE 102 07 501C 1, which has a plurality of sensor arrangements, which in turn are formed by drill holes formed in the axial direction of the measuring roll in a measuring-roll body and force sensors disposed therein. The drill holes extend parallel to a circumferential surface of the measuring roll, the respective force sensors being inserted into the drill holes and braced therein in such a manner that a force acting on the circumferential surface, for example from a tape, can be measured. The advantage here is that the circumferential surface is not influenced by the sensor arrangements and is therefore uninterruptedly or completely closed with the same material properties at all times. A disadvantage, on the other hand, is that the drill holes, which are inserted parallel to the circumferential surface, can only be formed at a safe distance from the circumferential surface, so that the measuring sensitivity of the force sensors is comparatively low. It is also takes comparatively great effort to produce the drill holes and to dispose the sensors within the drill holes. Sensor arrangements designed in this manner are therefore only suitable for measuring large forces or rather tensile forces on thicker tapes or webs.

Measuring rolls, as known from DE 42 36 657 A1, are regularly used to measure comparatively small tensile forces. Here, sensor arrangements are designed in such a manner that drill holes are made in a circumferential surface of a measuring-roll body, a force sensor being inserted into each of the drill holes. The corresponding drill holes are closed with a lid which is flush with a circumferential surface of the measuring roll. The lid is comparatively thick, like a plug, and is fixed in the drill hole, for example via a screw connection. This also makes it possible to pretension the force sensor. In order to achieve the highest possible measuring sensitivity, the lid can be moved minimally within the drill hole, which requires the formation of a gap between the lid and the drill hole. The gap is sealed using an O-ring, plastic material, adhesive material or similar, for example, to prevent dirt from entering the gap or the drill hole. Overall, even small tensile forces of relatively thinner tapes can be measured in this manner. The disadvantage, however, is that the required gap can easily leave marks on the tape running over the measuring roll. If the gaps are not completely sealed, dirt can easily accumulate in them, which can falsify the measurement result. It is therefore also known to provide a measuring-roll body with a so-called shrink ring in order to cover drill holes formed in the circumferential surface of the measuring-roll body without leaving a gap. However, shrink rings of this type require a wall thickness which has a negative effect on measuring sensitivity and are comparatively expensive to manufacture.

The object of the invention at hand is therefore to propose a measuring roll and a method for its production which both allow a high measuring sensitivity without influencing a tape quality.

This object is attained by a measuring roll having the features of claim 1 and a method for producing a measuring roll having the features of claim 17.

The measuring roll for measuring at least one property, in particular a tape tensile force, a tape temperature or the like, of a good guided over the measuring roll has a measuring-roll body which forms a circumferential surface of the measuring roll, the measuring roll having at least one sensor arrangement, the sensor arrangement being formed by at least one cavity which is formed within the circumferential surface and in which at least one sensor is received, the cavity being designed so as to be closed flush with the circumferential surface by means of a lid of the sensor arrangement, the lid being in a mechanically operative connection with the sensor, the lid being substance-bonded with the measuring-roll body, the lid on the circumferential surface having a wall.

In the measuring roll according to the invention, the cavity in the circumferential surface is formed radially, with at least one sensor disposed therein. The lid closes the cavity completely and thus without a gap, meaning no impurities can penetrate into a gap or another opening of the sensor arrangement in the circumferential surface. Nevertheless, the lid also forms the circumferential surface and is in a mechanically operative connection with the sensor in such a manner that forces acting directly on the circumferential surface can also act directly or indirectly on the sensor essentially via the lid. The gap-free design of the sensor arrangement is made possible by the fact that the lid is substance-bonded to the measuring-roll body. The substance-bonded connection can be designed in such a manner that the sensor arrangement and/or the cavity is completely and tightly sealed on the side of the circumferential surface. The fact that no gap or a gap closed with a comparatively soft material is formed can effectively prevent the formation of marks on a tape. The substance-bonded connection between the lid and the measuring-roll body also makes it possible to make the lid sufficiently thin so that the already low forces acting on the circumferential surface can be transmitted to the sensor via the lid. Overall, the measuring roll makes it possible to measure, for example, tape tensile forces on comparatively thin tapes and/or webs without the corresponding tape being influenced by the measuring roll.

According to the invention, the lid is formed on the circumferential surface with a wall which preferably has a specific shape on the circumferential surface. The wall is formed in such a manner that it forms sections of the circumferential surface. The cavity is then at least completely covered by the wall. An outer contour of the wall can be designed to match an inner contour of the cavity. It is also possible for an outer contour of the wall to cover an inner contour of the cavity and/or for a section to be much larger than the cavity. It is essential that the wall and/or a wall thickness of the wall is comparatively thin compared to an opening cross section of the cavity. The wall can then also be substance-bonded to the measuring-roll body at its outer edges and/or outer contour. A comparatively thin wall can be so flexible that even very small forces can be transmitted to the sensor via the lid.

The cavity can be formed by a blind hole in the measuring-roll body, the blind hole being able to extend in the direction of its radius in relation to the measuring-roll body. The blind hole can thus be formed orthogonally relative to a longitudinal axis of the measuring-roll body and/or the measuring roll. The blind hole can be formed by drilling or milling. The blind hole can have a round cross section or, in principle, any other cross section with a specific shape, for example in the form of an elongated hole, a groove, an ellipse, an oval, a polygon or the like. A plurality of sensors can then also be received in the cavity.

The wall can have a wall thickness S, the minimum wall thickness S being able to be ≥0.2 mm to ≤10 mm, preferably ≥2 mm to ≤5 mm, particularly preferably ≥2 mm to ≤3 mm. At least sections of the wall can be of uniform thickness. As sections of the wall form the circumferential surface, the wall has a radius of the measuring roll on the circumferential surface of the wall. The wall can therefore be formed with a uniform wall thickness in the form of a bent sheet with an elliptical contour. Alternatively, the wall can also be produced by turning a plug or punching tool which is only inserted a few mm into the cavity. In particular, a wall thickness S can then also vary to a certain degree, for example within the ranges specified here.

The sensor can be a force sensor, the sensor arrangement being able to have a support body for supporting the force sensor in the cavity and a pre-tensioning unit for the force-fit connection between the force sensor and the measuring roll. The support body can, for example, rest directly against the force sensor so that the force sensor is positioned and fixed in the correct position. The force sensor can be a piezoelectric sensor, in which case the support body can advantageously rest against an axial end of the force sensor and cover it entirely. The pre-tensioning unit can be designed in such a manner that the force sensor can be subjected to a defined pre-tensioning force. The pre-tensioning unit can be formed on the one hand by the measuring-roll body or on the measuring-roll body and/or by the support body.

The axial ends of the force sensor can be disposed between a bottom of the cavity and the support body, the support body being able to entirely cover the force sensor. The bottom of the cavity can be entirely flat so that the force sensor can be positioned directly on the bottom. Alternatively, the force sensor can also be disposed on the bottom under intermediate layers of a flat plate or the like. If the support body entirely covers the force sensor, a force applied via the lid can also act completely on the force sensor. This can further improve measurement accuracy. The lid can form the support body. In principle, the support body can rest against the lid, i.e., be disposed between the force sensor and the lid. If the lid forms the support body, the support body can be attached to the cavity together with the lid. This also reduces the number of parts, which simplifies the production of the measuring roll.

The support body can have an external thread which can be mated with an internal thread in a bottom of the cavity. The support body can then be positioned and fastened particularly easily in the cavity. The support body can also have a collar which can rest against an axial end of the force sensor. In addition, the force sensor can be designed in the shape of a ring or disk with a through hole. The support body can then also form the pre-tensioning unit with which the force sensor can be fixed by mating the external thread to the internal thread in the cavity. The support body can therefore be designed in the form of a screw or a thread pin.

Alternatively, on its outer edge, the lid has a sleeve having an external thread, which is mated with an internal thread in an inner wall of the cavity. The thread can be a fine thread so that the sleeve-shaped lid can be screwed into the cavity in the manner of a plug. After having been screwed in, the substance-bonded connection can be formed with the measuring-roll body. The design of the thread allows the lid to be positioned particularly precisely and easily in the cavity to form the substance-bonded connection.

The threads can form the pre-tensioning unit. For example, a collar can be formed on the support body, via which a pre-tensioning force can be exerted on the force sensor. The pre-tensioning force can be easily adjusted via the threads.

The support body can be designed as a punching tool, which can be disposed so that its longitudinal axis extends in the direction of its radius in relation to the measuring-roll body, the punching tool being able to be disposed between the circumferential surface and the sensor. If the lid on the circumferential surface is formed with a wall, the punching tool can thus be disposed between the wall and the sensor. Furthermore, the punching tool can be formed on the wall in such a manner that the lid forms the punching tool. The punching tool can be designed in such a manner that it is disposed coaxially in relation to the lid and the cavity. The lid can have an outer contour and a diameter D1 limiting the outer contour, the support body being able to have a cross section and a diameter D2, which limits the cross section D2, at or adjacent to a wall formed by the lid on circumferential wall. The lid or, for example, a blind hole of the cavity can be formed having the outer diameter D1 in such a manner that the outer contour corresponds to the diameter D1. Nevertheless, the lid and/or the cavity can be designed in such a manner that the outer contour lies within the diameter D1 and/or in its plane, the outer contour then deviating at least partially from the diameter D1 due to its basically arbitrary shape. The diameter D1 then corresponds to a relative distance from the two most distant points of the outer contour. The cross section of the support body can correspond to the diameter D2. Nevertheless, the support body can be designed in such a manner that the cross section lies within the diameter D2 and/or in its plane, the cross section then deviating at least partially from the diameter D2 due to its basically arbitrary shape. The diameter D2 then corresponds to a relative distance from the two most distant points of the cross section. If, for example, the support body is designed as a body of revolution and is disposed coaxially to the cavity on the wall or is molded onto the wall, an annulus and/or an annular wall is formed between the outer diameter D1 and the inner diameter D2. A force acting on the circumferential surface in the area of the lid can then be transmitted evenly to the support body. The annular wall then acts in the manner of a membrane or spring in such a manner that movement of the support body in the direction of its longitudinal axis is made possible, even if only minimally.

A dimension of the diameter D1 can range from D1≥10 mm to ≤100 mm, preferably ≥10 mm to ≤50 mm.

A dimension of the diameter D2 can be in a range of D2≥2 mm to ≤50 mm, preferably ≥2 mm to ≤30 mm.

A ratio K of the diameters D1 to D2 can be ≥1.1 to ≤100, preferably ≥1.1 to ≤50. It has been proven to be possible to achieve sufficient force transmission via the support body to the force sensor or a corresponding cross section of the support body in relation to a cross section of the lid, which is defined by the diameter D1, with the specified ratios. If other ratios are selected, the lid may not be sufficiently flexible or the desired introduction of the force acting on the lid or the circumferential surface into the support body cannot be guaranteed.

The lid can be connected to the measuring-roll body by means of welding, preferably laser beam welding. A continuous weld seam can be formed along an outer contour of the lid in the area of the circumferential surface. The lid can lie flush against an inner contour of the cavity or cover the cavity to some extent. Consequently, the weld can be formed at a butt joint between the lid and the measuring-roll body or an overlap joint. A shoulder can therefore also be formed in the measuring-roll body in the area of the circumferential surface in which the lid is inserted or disposed in such a manner that an overlap joint is formed with the measuring-roll body. In particular, laser beam welding can be used as a welding process, as the materials to be joined are only slightly thermally affected and filler materials may not be required. After welding, any weld seam or unevenness between the circumferential surface of the lid and the circumferential surface of the measuring-roll body can be evened out by machining, such as grinding and/or turning, in a further work step.

A material of the lid, the measuring-roll body and a weld seam on the circumferential surface can be designed with a matching hardness. This can be made possible, for example, by using similar or essentially similar materials, such as an identical steel for the material of the lid and the material of the measuring-roll body. In addition, the weld seam and the areas of the lid and the measuring-roll body surrounding the weld seam can be heat treated in such a manner that the hardness of the materials in the area of the weld seam is not significantly affected by an increase in temperature during welding.

The circumferential surface can be formed with a surface application by means of build-up welding, preferably laser build-up welding. This makes it possible to apply a comparatively thin layer of material to the circumferential surface of the measuring-roll body or the lid, the material always having the same physical properties, in particular strength properties. Such a surface application can also ensure that the circumferential surface has a comparatively high hardness.

The measuring roll can have a plurality of sensor arrangements, which can be disposed in a uniform pattern across the circumferential surface in a circumferential direction and a longitudinal direction of the measuring roll. For example, the sensor arrangements can be disposed at the exact same distance from each other in a longitudinal direction of the measuring roll and/or in a radial direction along a circumference of the measuring roll. This makes it possible to detect a force essentially continuously when a film strip, for example, comes into contact with the measuring roll, as one of the sensor arrangements can then always come into contact with the film strip. For example, the measuring roll may have 10, 40, 60, 100 or more sensor arrangements. Preferably, the sensor arrangements are formed or disposed in a spiral along the measuring roll in relation to a circumference of the measuring roll.

In the method for producing a measuring roll for measuring at least one property, in particular a tape tensile force, tape temperature or the like, of a good guided over the measuring roll, at least one cavity is formed in a measuring-roll body within a circumferential surface of the measuring-roll body of the measuring roll, at least one sensor being received in the cavity, the cavity being closed by a lid, a mechanical operative connection being established between the lid and the sensor, the lid being substance-bonded with the measuring-roll body, at least the lid being machined subsequently in such a manner that the lid is flush with the circumferential surface. With regard to the advantages of the method according to the invention, reference is made to the description of the advantages of the measuring roll according to the invention.

According to the invention, when manufacturing the measuring roll, it is provided in particular that the lid is substance-bonded to the measuring-roll body. This substance-bonded connection can be achieved by welding, for example. In order to obtain a completely flat surface relative to a longitudinal extension of the measuring roll, a machining of at least the lid is intended. During machining, material can also be removed from the measuring-roll body. Machining can be carried out, for example, by grinding with a grinding wheel and/or turning. Grinding and/or turning can also be carried out in several steps. It is also possible to polish the circumferential surface. In addition, heat treatment of the circumferential surface as a whole or partially, for example in the area of the lid and in particular the substance bond, can be intended.

Further advantageous embodiments of the method are derived from the descriptions of features of the dependent claims referring to claim 1.

The invention is explained in more detail below with reference to the enclosed drawings.

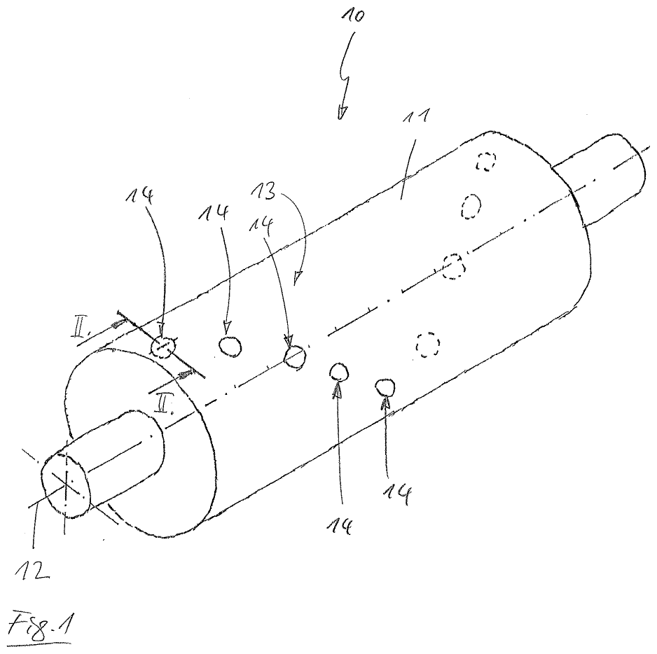

FIG. 1 shows a perspective view of a measuring roll.

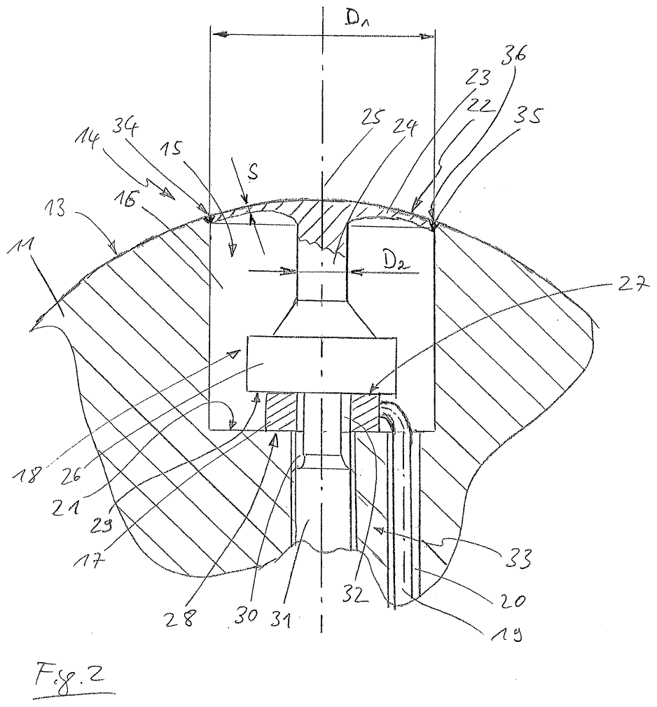

FIG. 2 shows a partial sectional view of a sensor arrangement along a line II-II from FIG. 1.

FIG. 1 shows a schematic view of a measuring roll 10 by means of which a measurement of a tape tensile force of a tape (not shown here), for example a metal foil or the like, which is guided over the measuring roll 10, can be carried out. The measuring roll 10 is essentially formed by a measuring-roll body 11, which is rotatable about a rotation axis 12. A plurality of sensor arrangements 14 are formed on a circumferential surface 13 of the measuring roll 10, a force acting on the circumferential surface 13 from the circumferential surface 13 in the direction of the rotation axis 12 being able to be measured by means of the sensor arrangements. The sensor arrangements 14 are distributed across the circumferential surface 13 along the rotation axis 12 essentially in a spiral shape, so that a tape resting against the measuring roll 10 or the circumferential surface 13 always overlapping with a sensor arrangement 14 and so that a tape tensile force can be continuously measured.

FIG. 2 shows a partial sectional view of a sensor arrangement 14 in a schematic view. In the measuring-roll body 11, a cavity 15 is formed by a blind hole 16. In this context, the blind hole 16 extends in the direction of a radius of the measuring-roll body 11 or on the rotation axis 12. A force sensor 17 is received within the cavity 15 and fixed by means of a support body 18. The force sensor 17 is connected to evaluation means (not shown here) via a connection cable 19. The connection cable 19 is guided out of the cavity 15 via a drill hole 20 in a bottom 21 of the cavity 15. Furthermore, the cavity 15 is sealed flush with the circumferential surface 13 by means of a lid 22 of the sensor arrangement 14. For this purpose, the lid 22 is in a mechanical operative connection with the force sensor 17. In addition, the lid 22 is substance-bonded to the measuring-roll body 11.

The lid 22 is formed on the circumferential surface 13 with a wall 23, which is relatively thin and has a wall thickness S of essentially the same thickness. The lid 22 also forms the support body 18 or is formed in one piece with it. Starting from the wall 23, a punching tool 24 of the support body 18 extends, which is disposed with its longitudinal axis 25 extending relative to the measuring-roll body 11 in the direction of its radius. The punching tool 24 is designed with a diameter D2. Furthermore, the punching tool 24 or the support body 18 forms a collar 26. The axial ends 27 and 28 of the force sensor 17 are now clamped between the bottom 21 and a support surface 29 of the collar 26 so that it rests flat against the latter. A thread bore 30 is formed in the bottom 21, a thread pin 31 formed on the support body 18 being mated with the thread bore 30. The thread pin 31 penetrates a through opening 32 in the force sensor 17. By screwing the support body 18 into the thread bore 30, it is thus possible on the one hand to close the cavity 15 and on the other hand to pre-tension the force sensor 17 in the desired manner during assembly. The thread bore 30 and the thread pin 31 thus form a pre-tensioning unit 33.

The lid 22 is designed with a diameter D1 which essentially corresponds to the diameter of the blind hole 16. Deviating from the view shown here, the lid 22 can project radially beyond the circumferential surface 13 to some extent when it is mounted. In this area of the lid 22, which is no longer shown here, an internal hexagon or the like can be formed, for example, so that the lid 22 can then be screwed in easily and with a desired torque. The area of the lid 22 not shown here can be removed after assembly is complete, for example by grinding, turning or the like of the circumferential surface 13. After screwing in the lid 22, a weld seam 35 is formed along an outer contour 34 of the wall 23 between the wall 23 and an edge 36 of the blind hole 16 on the circumferential surface 13 by means of welding, in particular laser beam welding. The weld seam 35 is essentially circular or oval and completely closed, so that the lid 22 is substance-bonded to the measuring-roll body 11. After welding, the area of the lid 22 which is no longer shown here can be removed by grinding and/or turning. Overall, this makes it possible to form a completely closed circumferential surface 13.

Optionally, heat treatment, in particular of the lid 22 in the area of the circumferential surface 13, can be intended. The fact that the wall 23 is comparatively thin makes it easy to transmit the force acting radially on the circumferential surface 13 in the area of the lid 22 to the force sensor 17 via the punching tool 24. This means that even comparatively low tape tensile forces can be measured from thin tapes. Since the circumferential surface 13 is completely closed due to the substance-bonded connection, no undesirable dirt of the lid 22 in the area of the circumferential surface 13 or on the measuring-roll body 11 can occur. Furthermore, marks from sensor arrangements 14 on a tape are not possible here.

1. A measuring roll (10) for measuring at least one property of a good guided over the measuring roll, the measuring roll having a measuring-roll body (11) which forms a circumferential surface (13) of the measuring roll, the measuring roll having at least one sensor arrangement (14), the sensor arrangement being formed by at least one cavity (15) which is formed within the circumferential surface and in which at least one sensor is received, the cavity being designed so as to be closed flush with the circumferential surface by means of a lid (22) of the sensor arrangement, the lid being in a mechanically operative connection with the sensor, wherein the lid is substance-bonded with the measuring-roll body, the lid on the circumferential surface having a wall (23).

2. The measuring roll according to claim 1, wherein the cavity (15) is formed by a blind hole (16) in the measuring-roll body (11), the blind hole extending in the direction of its radius in relation to the measuring-roll body.

3. The measuring roll according to claim 1, wherein the wall (23) has a wall thickness S, the minimum wall thickness S being >0.2 mm to ≤10 mm.

4. The measuring roll according to claim 1, wherein the sensor is a force sensor (17), the sensor arrangement (14) having a support body (18) for supporting the force sensor in the cavity (15) and a pre-tensioning unit (33) for the force-fit connection between the force sensor and the measuring roll (10).

5. The measuring roll according to claim 4, wherein the axial ends (27, 28) of the force sensor (17) are disposed between a bottom (21) of the cavity (15) and the support body (18), the support body entirely covering the force sensor.

6. The measuring roll according to claim 4, wherein the lid (22) forms the support body (18).

7. The measuring roll according to claim 4, wherein the support body (18) has an external thread which is mated with an internal thread in a bottom (21) of the cavity (15).

8. The measuring roll according to claim 4, wherein on its outer edge, the lid has a sleeve having an external thread, which is mated with an internal thread in an inner wall of the cavity.

9. The measuring roll according to claim 7, wherein the threads form a pre-tensioning unit (33).

10. The measuring roll according to claim 4, wherein the support body (18) is designed as a punching tool, which is disposed so that its longitudinal axis (25) extends in the direction of its radius in relation to the measuring-roll body (11), the punching tool being disposed between the circumferential surface (13) and the sensor.

11. The measuring roll according to claim 4, wherein the lid (22) has an outer contour and a diameter D1 limiting the outer contour, the support body (18) having a cross section and a diameter D2, which limits the cross section D2, at or adjacent to a wall (23) formed by the lid on circumferential wall (13).

12. The measuring roll according to claim 11, wherein D1 is >10 mm to ≤100 mm.

13. The measuring roll according to claim 11, characterized in that D2 is ≥2 mm to ≤50 mm.

14. The measuring roll according to claim 11, wherein a ratio K of D1 to D2 is ≥1.1 to ≤100.

15. The measuring roll according to claim 1, wherein the lid (22) is connected to the measuring-roll body (11) by means of welding.

16. The measuring roll claim 1, wherein the measuring roll (10) has a plurality of sensor arrangements (14), which is disposed in a uniform pattern across the circumferential surface (13) in a circumferential direction and a longitudinal direction of the measuring roll.

17. A method for producing a measuring roll (10) for measuring at least one property, of a good guided over the measuring roll, at least one cavity (15) being formed in a measuring-roll body (11) within a circumferential surface (13) of the measuring-roll body of the measuring roll, at least one sensor being received in the cavity, the cavity being closed by a lid (22), a mechanical operative connection being established between the lid and the sensor, the method comprising substance-bonding the lid with the measuring-roll body, at least the lid being machined subsequently in such a manner that the lid is flush with the circumferential surface.
